(19) United States
(12) Patent Application Publication
(10) Pub. No.: US 2021/0233079 A1
(43) Pub. Date: Jul. 29, 2021

(54) USER AUTHENTICATION AND PAYMENT PROCESS OF IMAGE FORMING APPARATUS

(71) Applicant: HEWLETT-PACKARD DEVELOPMENT COMPANY, L.P., Spring, TX (US)

(72) Inventors: Hyunsuk LEE, Seongnam-si (KR); Min Hyuk KIM, Seongnam-si (KR); Minae OH, Seongnam-si (KR); Seonae PARK, Seongnam-si (KR)

(73) Assignee: Hewlett-Packard Development Company, L.P., Spring, TX (US)

(21) Appl. No.: 17/051,271

(22) PCT Filed: Nov. 5, 2018
(86) PCT No.: PCT/KR2018/013319

§ 371 Date: Oct. 28, 2020

(30) Foreign Application Priority Data
Jul. 11, 2018 (KR) 10-2018-0080567

(51) Int. Cl. G06Q 20/40; G06Q 20/02; G06F 3/12; G06F 21/31

(52) U.S. Cl. CPC G06Q 20/4014; G06Q 20/02; G06F 21/31; G06F 3/1222; G06F 3/1285; G06F 3/1238

(57) ABSTRACT

An image forming apparatus and method are provided. The image forming apparatus includes a print engine to perform a print job, a memory to store a first application associated with user authentication, a second application associated with performing a function of the image forming apparatus, and a third application associated with payment processing, and a processor to perform a user authentication using the first application, to perform a payment processing by providing authentication information of the first application to the third application during a payment operation for an authenticated user, and, based on the payment processing being completed, to control the print engine to perform an operation requested by a user by using the second operation.

### BACKGROUND ART

An image forming apparatus generally operates to print out print data generated at a terminal such as a computer onto a printing paper. Examples of the image forming apparatus may include a copier, a printer, a facsimile, a scanner, or a multi-function peripheral (MFP) in which the above functions are combined and implemented as one apparatus.

In recent years, image forming apparatuses have used an application provided by a third-party business.

### DISCLOSURE OF INVENTION

### BRIEF DESCRIPTION OF DRAWINGS

FIG. 1 is a diagram illustrating an image forming system, according to an example;

FIG. 2 is a block diagram illustrating a brief configuration of an image forming apparatus, such as the image forming apparatus of FIG. 1, according to an example;

FIG. 3 is a block diagram illustrating a more detailed configuration of an image forming apparatus, such as the image forming apparatus of FIG. 1, according to an example;

FIG. 4 is a diagram provided to explain an authentication and payment operation, according to a first example;

FIG. 5 is a diagram provided to explain an authentication and payment operation, according to a second example;

FIG. 6 is a diagram provided to explain an authentication and payment operation, according to a third example;

FIG. 7 is a diagram provided to explain an authentication and payment operation, according to a fourth example;

FIG. 8 is a sequence diagram provided to explain an operation in a plurality of applications and a plurality of servers, according to an example; and

FIG. 9 is a diagram of a print controlling method, according to an example.

Throughout the drawings, it should be noted that like reference numbers are used to depict the same or similar elements, features, parts, components, and structures.

### MODE FOR THE INVENTION

One or more examples will be described below in greater detail with reference to the accompanying drawings. The examples described below may be modified and implemented in various different forms. In order to more clearly describe the features of the examples, a detailed description of known matters to those skilled in the art will be omitted.

In the present disclosure, a case in which any one feature is connected with another feature includes a case in which the features are directly connected with each other and a case in which the features are indirectly (e.g., electrically) connected with each other with other features interposed therebetween. Further, when a certain feature is stated as “comprising” another certain feature, unless otherwise stated, this means that the certain feature may include still another feature, rather than foreclosing the same.

The term “image forming job” as used herein may mean various jobs related to the image (e.g., printing, copying, scanning, or faxing), such as forming an image or creating/storing/transmitting an image file. In addition, “job” may mean not only an image forming operation but also a series of processes necessary for performing an image forming operation.

An image forming apparatus generally operates to print out print data generated at a terminal such as a computer onto a printing paper. An example of an image forming apparatus includes a copier, a printer, a facsimile, a scanner, and a multi-function printer (MFP) that provides combined functionality of at least two of the single apparatuses. The image forming apparatus may refer to any apparatus capable of performing an image forming operation, such as a printer, a copier, a scanner, a fax machine, an MFP, a display apparatus, or the like.

In addition, “content” may refer to any type of data that is subject to an image forming operation, such as a photo, an image, a document file, or the like.

In addition, “print data” may refer to data that is converted into a format printable in a printer. If a printer supports direct printing, the file itself may be print data.

In addition, “user” may refer to a person who performs an operation related to an image forming operation using an image forming apparatus or a device connected to the image forming apparatus via wire or wirelessly. In addition, “manager” may refer to a person who has the authority to access all functions and the system of the image forming apparatus. The “manager” and the “user” may be the same person.

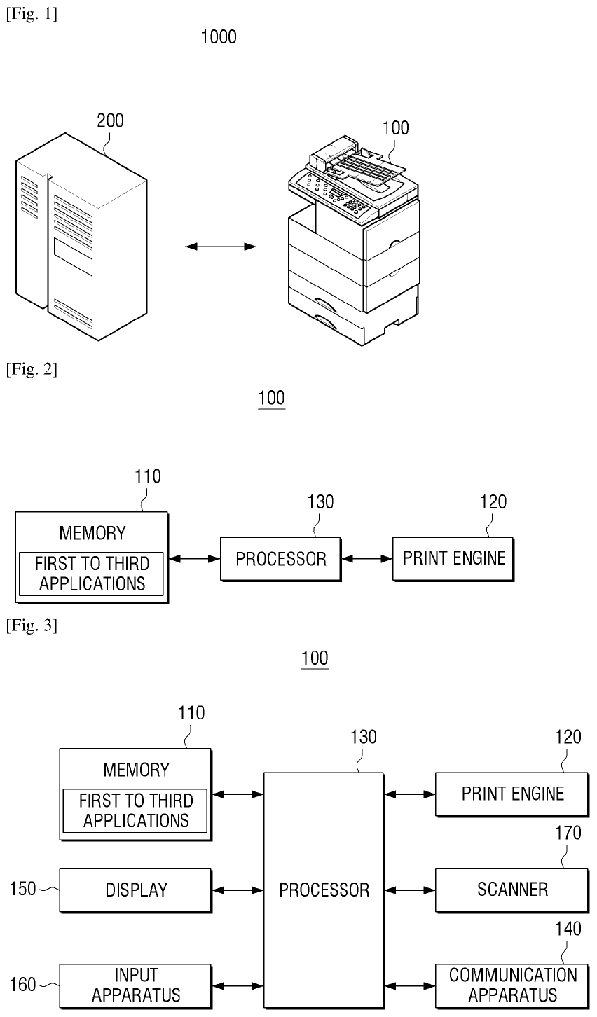

FIG. 1 is a diagram illustrating an image forming system, according to an example.

Referring to FIG. 1, an image forming system 1000 may include an image forming apparatus 100 and a management server 200.

A plurality of applications may be installed in the image forming apparatus 100, and the image forming apparatus 100 may provide a user with a function of an image forming apparatus by means of an installed application. For example, a first application for user authentication, a second application for print job processing, and a third application for payment processing may be installed in the image forming apparatus 100.

The first application and the third application may each be a third-party application which is generated by a 3rd-party business rather than a manufacturer of the image forming apparatus 100. In addition, the second application may be provided by a manufacturer of the image forming apparatus 100, and may be an application pre-installed in the image forming apparatus 100.

The image forming apparatus 100 may perform a user requested operation by using a plurality of pre-installed applications. For example, the image forming apparatus 100 may perform user authentication using the first application, receive input of a user operation command by means of the second application after the user authentication, and calculate a payment amount corresponding to the received operation command.

In addition, the image forming apparatus 100 may provide authentication information provided by the first application and the calculated payment amount to the third application, and perform payment processing by means of the third application. For example, the second application may calculate a payment amount, and provide the authentication information and the calculated payment amount to the third application.

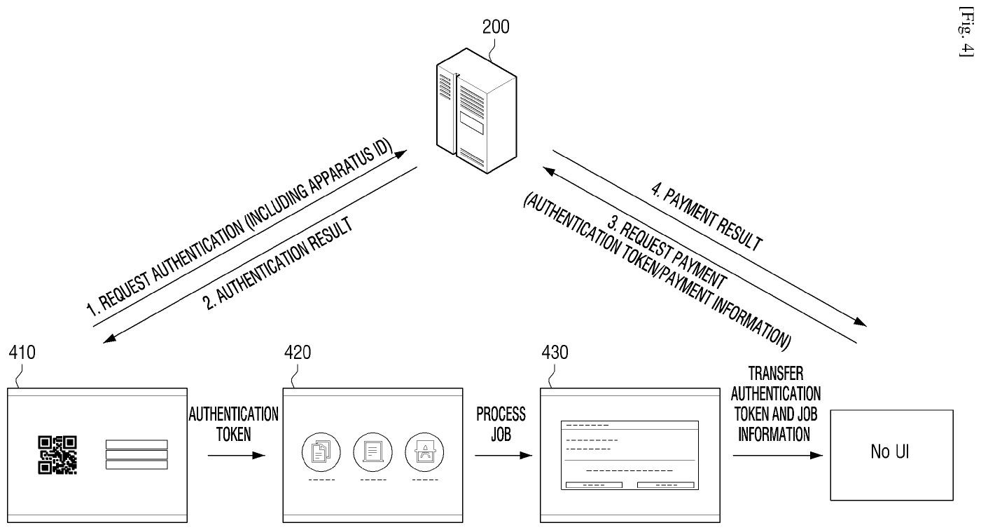

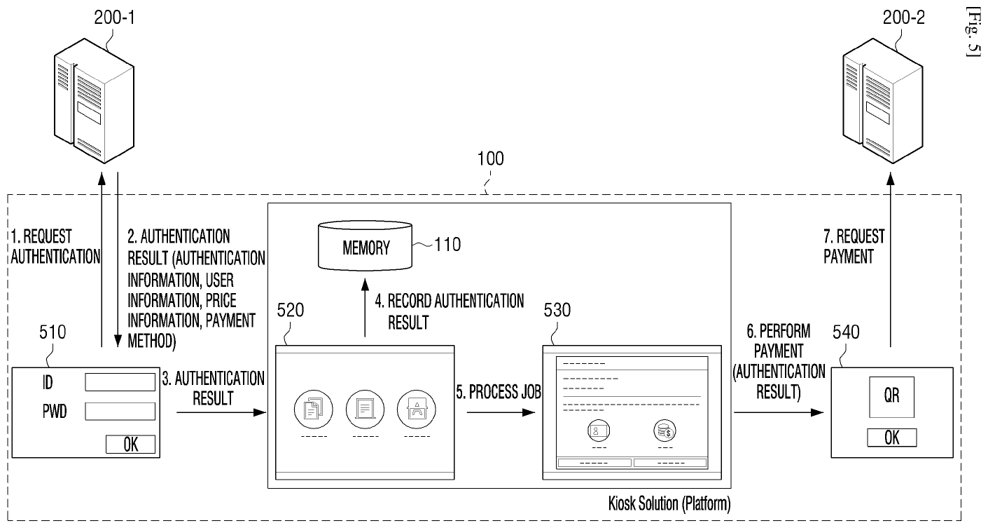

In addition, the image forming apparatus 100 may perform an operation for the payment-processed operation command by means of the second application. An example constitution and operation of the image forming apparatus 100 will be described below by referring to FIGS. 2 and 3.

The management server 200 may provide an installation file to the image forming apparatus 100. For example, the management server 200 may store an installation file which is capable of installing an application generated by a 3rd-party in the image forming apparatus 100, and provide the stored installation file to the image forming apparatus 100.

In addition, the management server 200 may store a plurality of pieces of user information. In addition, the management server 200 may process user authentication using a plurality of pieces of stored user information. For example, the management server 200 may receive an authentication request including user information (e.g., identification/password (ID/PW), a quick reference (QR) code, a personal identification number (PIN) code, etc.) from the image forming apparatus 100, perform a user authentication using user information included in the received authentication request and the plurality of pieces of stored user information, and provide the authentication result to the image forming apparatus 100.

The authentication result may include authentication information, such as an ID, an authentication token, an expiration date of an authentication token, etc., and user setting data corresponding to an authenticated user.

The authentication token may be information (e.g., an instance ID, a key value, etc.) which is generated to identifying an authenticated user after an authentication server authenticates the user, and the expiration date may be information about a period in which the corresponding authentication token is available. An authentication code may be used to identify the entire authentication result.

In addition, the user setting data may be information corresponding to a user stored in the management server 200, which may include a language used by the user, an address book of the user, a means for payment to be applied to the corresponding user, a server access address for using the corresponding payment means, and the like.

In addition, the management server 200 may perform a payment process request received from the image forming apparatus 100, and notify the image forming apparatus 100 of the payment process result.

As described above, in the image forming system 1000 according to an example, a 3rd-party application to perform a user authentication and a payment process may be installed and used and thus, a function of the image forming apparatus 100 may be readily expanded without modifying a pre-installed application. In addition, by means of an application pre-installed in the image forming apparatus 100, a basic function control, calculation of a payment amount, data transfer between applications, etc. of the image forming apparatus 100 are supported and thus, a 3rd-party engineer can more readily develop a third-party application.

In FIG. 1, it is illustrated and described that the image forming apparatus 100 and the management server 200 are directly connected to each other, but in another example, the image forming apparatus 100 and the management server 200 may be connected via a different apparatus, such as a router, a wireless router, and the like.

In addition, it is described that all of providing an installation file, authentication processing, payment processing, etc. are carried out by the management server 200. However, the respective functions described above may be performed by an additional server, and a plurality of management servers may be used to process a single function. For example, in a case in which a payment processing of the image forming apparatus 100 is divided into a micropayment, a card payment, etc., a server processing a micropayment and a server processing a card payment may be separated from each other and the image forming apparatus 100 may request a server corresponding to a selected payment method to make a payment.

FIG. 2 is a block diagram illustrating a brief configuration of an image forming apparatus, such as the image forming apparatus of FIG. 1, according to an example.

Referring to FIG. 2, the image forming apparatus 100 may include a memory 110, a print engine 120, and a processor 130.

The memory 110 stores various programs necessary for controlling functions of the image forming apparatus 100. The various programs may include a plurality of applications and an operating system in which the applications described above are driven. As an example, the operating system may be Google Android™ which is an open platform.

The plurality of applications may include a first application associated with user authentication, a second application associated with performing a function of the image forming apparatus 100, and a third application for payment processing. In addition, in a case in which the image forming apparatus 100 includes a scanner, which will be described later with reference to FIG. 3, the image forming apparatus 100 may include a fourth application associated with performing a scan function.

The first application may be an application associated with user authentication, which may perform a user interface (UI) display function for receiving an input of data for authentication, a function of performing a user authentication using data received through the displayed UI, a function of communicating with an external apparatus (e.g., the management server 200) when it is necessary to communicate with an external apparatus in an authentication process, etc.

A variety of authentication methods may be applied in the image forming apparatus 100. For example, a method of receiving an input of an ID and a password from a user and performing an authentication processing, a method of performing authentication using a QR code, a method of performing authentication processing through an radio frequency identification (RFID) communication with an ID card, a method of using body information of a user (e.g., fingerprint, iris, vein, etc.), etc. may be used.

Various authentications may be applied in addition to the methods described above and it is necessary to support an authentication method specialized for an environment in which the image forming apparatus 100 is used. Thus, the first application suitable for an application environment of the image forming apparatus 100 may be manufactured by a third-party business.

The image forming apparatus 100 according to an example may perform an authentication procedure using a first application manufactured by a 3rd-party business. The first application may be referred to as an authentication application or an authentication app.

Various methods may be applicable to an authentication procedure as described above and thus, a plurality of first applications manufactured by different 3rd-party manufacturers may be installed in an image forming apparatus. For example, an application using an ID and a password and an application using an RFID tag may be installed in the image forming apparatus 100.

The third application is an application associated with payment processing, which may perform a function of providing a UI for payment processing, a function of requesting payment processing to an external server, and a function of providing a payment result to a second application. The third application may be referred to as a payment application or a payment app.

A variety of payment methods may be applied in the image forming apparatus 100. For example, a method of payment processing by receiving an input of a pin code, a card payment method, a micro payment method using a smartphone, etc. may be used.

Various payment methods may be applied in addition to the methods described above and a payment method may vary according to a country in which the image forming apparatus 100 is used and the advancement of technology. Thus, it is somewhat difficult for the manufacturer to support all payment methods. Accordingly, the third application may be manufactured by a 3rd-party manufacturer as well.

Various methods may be applicable to a payment processing as described above and thus, a plurality of third applications manufactured by different 3rd-party manufacturers may be installed in an image forming apparatus. In addition, there may be cases where a physical hardware configuration is required for payment processing. For example, for card payment, an apparatus such as a card terminal capable of reading a magnetic card or an integrated circuit (IC) card may be required. In this case, the third application described above may be installed or stored in a card terminal connected to an image forming apparatus.

In order for a 3rd-party business to develop an authentication application or a payment processing application, it is necessary to know a program associated with a basic function of an image forming apparatus and to, if necessary, modify a code of a basic program of the image forming apparatus 100.

In this case, the reliability of a program code is deteriorated and, if a basic screen of an image forming apparatus is changed, a large amount of modifications are required.

Accordingly, a second application may be used so that a basic program and a 3rd-party application may interact with each other without modifying a basic program of an image forming apparatus by a 3rd-party business.

The second application is a basic application that is provided by a manufacturer of the image forming apparatus 100, which may perform functions such as controlling a print function of an image forming apparatus, providing a UI for receiving a print command and a print setting, calculating a charged amount, a data relaying function between 3rd-party applications, etc.

In an example, the second application may be implemented as a plurality of applications. In addition, some or all functions of the second application may be performed in a platform of an image forming apparatus. The second application may be referred to as a kiosk application, a kiosk platform, etc.

The memory 110 may store print data which is received through an external apparatus. In addition, the memory 110 may store information such as an installation file, an authentication result (e.g., authentication information and user setting information), and the like, provided from the management server 200.

The memory 110 may be implemented by a storage medium in the image forming apparatus 100 or by an external storage medium, for example, a removable disk including a universal serial bus (USB) memory or a web server through a network. In an example, the memory 110 may include a plurality of memory devices, and may be implemented in a form in which each of the memory devices store data of different types or natures.

The print engine 120 may form an image on a printing paper by using various printing methods, such as an electrophotographic method, an inkjet method, a thermal transcription method, a thermal method, and the like. In the electrophotographic method, the print engine 120 may include a photosensitive drum, a charger, a developer, a transferring device, a fixing device, etc.

The processor 130 may control operations of the image forming apparatus 100. The processor 130 may be implemented as one apparatus, such as a central processing unit (CPU), and may be also implemented as a plurality of apparatuses, such as a clock generating circuit, a CPU, a graphic processor, and the like.

The processor 130 may perform a user authentication using a first application. In addition, the processor 130 may drive a third application in response to a print operation request for an authenticated user, and provide authentication information (e.g., an ID and an authentication token) of the first application to the third application. Accordingly, the third application may perform a payment processing using the provided authentication information.

When the payment processing is completed, the processor 130 may perform a user requested operation using a second application. For example, if the user requested operation is a print job, the print engine may be controlled to print a job requested by the user.

Although the above illustrates and explains an example of an image forming apparatus, various units may be additionally included in actual implementation. A further example will be described below with reference to FIG. 3.

FIG. 3 is a block diagram illustrating a more detailed configuration of an image forming apparatus, such as the image forming apparatus of FIG. 1, according to an example.

Referring to FIG. 3, the image forming apparatus 100 may include the memory 110, the print engine 120, the processor 130, a communication apparatus 140, a display 150, an input apparatus 160, and a scanner 170.

Operations of the memory 110 and the print engine 120 are explained with reference to FIG. 2, and thus a repeated explanation is omitted. In addition, operations of the processor 130 are explained in FIG. 2, and thus will not be further explained below for the sake of brevity. Only added elements in FIG. 3 will be explained below.

The communication apparatus 140 is formed to connect the image forming apparatus 100 to an external apparatus, and may be connected via not only a local area network (LAN) or the Internet but also a USB port or a wireless communication (e.g., Wi-Fi 802.11a/b/g/n, near field communication (NFC), Bluetooth, etc.) port. The communication apparatus 140 may be referred to as a “transceiver.”

The communication apparatus 140 may receive, from the management server 200, an installation file corresponding to an application. In addition, the communication apparatus 140 may request the management server 200 for user authentication, and receive an authentication result from the management server 200 in response to the request. The authentication result may include not only authentication information but also user setting data.

In addition, the communication apparatus 140 may request the management server 200 for payment processing, and receive the payment processing result from the management server 200.

In addition, the communication apparatus 140 may receive print data and content from a user terminal (e.g., a smartphone, a personal computer (PC), etc.), and transmit scan data generated in the scanner 170 to an external apparatus (not illustrated).

In addition, the communication apparatus 140 may perform a fax transception operation using a telephone wire or an Internet network.

In addition, the communication apparatus 140 may receive data required for authentication from an authentication apparatus (not illustrated) installed outside the image forming apparatus 100. For example, to perform authentication using biometric information (e.g., fingerprint), the communication apparatus 140 may receive biometric information from an authentication apparatus (e.g., a fingerprint scanner) capable of acquiring biometric information.

In addition, the communication apparatus 140 may receive data required for payment from a payment apparatus (not illustrated) installed outside the image forming apparatus 100. For example, to perform payment using an IC card, the communication apparatus 140 may receive card information from a card reader (not illustrated) or transfer authentication information to the card reader.

The display 150 may display various information provided from the image forming apparatus 100. In more detail, the display 150 may display a user interface window to select various functions provided by the image forming apparatus 100. For example, the display 150 may receive selection of a function of the image forming apparatus 100, and display a user interface window for receiving an option corresponding to the function. The displayed user interface window may be provided by the second application.

In addition, the display 150 may display a user interface window for receiving an input of data required for an authentication procedure. The displayed user interface window may be provided by the first application, and may have a plurality of areas for receiving an input of an ID, a password, etc. from a user or display a message requesting an RFID tag to be connected to the terminal.

The display 150 may display a user interface window for receiving selection of a payment processing method. The displayed user interface window may be provided by the second application, which may be, for example, a user interface window for selecting any one of the third applications installed in the image forming apparatus 100.

In addition, the display 150 may display a user interface window for receiving an input of data required for a payment processing and a payment processing result. The displayed user interface window may be provided by the third application.

In addition, the display 150 may display a payment result. The displayed user interface window may be provided by the third application which performs a payment processing.

The input apparatus 160 may receive an input of a user's function selection and a control command for the corresponding function. The function may include printing, copying, scanning, fax transmission, and the like. Such a function control command may be received through a control menu displayed on the display 150.

In addition, the input apparatus 160 may receive an input of user information for authentication processing and payment processing. The input apparatus 160 may be a keyboard, a mouse, a touch pad, a touch screen, and the like.

In addition, the input apparatus 160 may include a fingerprint scanner, an iris scanner, a vein scanner, an RFID reader, etc., or may receive input of user biometric information, card information, or ID information through an apparatus as described above.

The scanner 170 may generate a scan image by scanning a document. For example, the scanner 170 may radiate light onto a manuscript, receive the reflected light, and generate a scan image.

When an installation file for an application is received from the communication apparatus 140, the processor 130 may install the received installation file in the image forming apparatus 100.

In addition, when a request for user authentication is received, the processor 130 may perform a user authentication using a first application. In more detail, the processor 130 may drive the first application for user authentication, and control the communication apparatus 140 to transmit user information input through the input apparatus 160 to the management server 200 according to driving of the first application. The user information may include, for example, an ID/PW, QR code, pin code, etc.

In addition, when an authentication result is received through the communication apparatus 140, the processor 130 may control the display 150 to display a user interface window corresponding to the authentication result. In a case in which an authenticated user is identified, the processor 130 may control the display 150 to display a user interface window for receiving an input for performing a job by using a second application.

In a case in which an authentication result including user setting data is received from the management server 200, the processor 130 may control the display 150 to display a user interface window in which the received user setting data is reflected. For example, a user name may be displayed on one side of a user interface window for receiving an input for performing a job, an input of the number of print pages assigned (or outputtable) to a current user may be displayed, etc.

In addition, the processor 130 may control the display 150 to display a user interface window having only a function assigned to the corresponding user. For example, in a case in which the image forming apparatus 100 supports print, copy, fax, and scan functions and a user who performs authentication has only the right to print and copy, the processor 130 may control the display 150 to display a user interface window to select only print and copy functions.

If an unauthenticated user is identified, the processor 130 may control the display 150 to display a user interface window for performing an additional authentication using the first application, or may control the display 150 to display a user interface window for receiving an input for performing a job for the unauthenticated user by using the second application.

In addition, when an operation command is received via the input apparatus 160, the processor 130 may calculate a charged amount corresponding to the received operation command by using the second application. The processor 130 may calculate the charged amount based on a reference amount of payment provided from the management server 200.

In a case in which a plurality of third applications are installed in the image forming apparatus 100, that is, when a plurality of payment methods are available, the processor 130 may control the display 150 to display a user interface window for selecting a payment method.

When any one payment method is selected through the displayed user interface window, the processor 130 may drive a third application corresponding to the selected payment method, provide the calculated charged amount and authentication information (e.g., an authentication token) from among the authentication result provided by the first application, and perform payment processing according to an operation of the third application.

For example, the processor 130 may control the communication apparatus 140 to transmit, to the management server 200, the charged amount and authentication information (e.g., an authentication token) input according to an operation of the third application.

In a case in which a payment method selected by a user uses a card terminal (not illustrated) connected to the image forming apparatus 100, the processor 130 may control the communication apparatus 140 to provide a calculated charged amount and authentication information to the connected card terminal.

In a case in which an operation is requested by a non-authenticated user, the processor 130 may control the display 150 to display a user interface window for receiving an input of information (e.g., user information) required for payment processing by using the third application, and perform payment processing using information received from the user and a charged amount provided by the second application.

When the payment processing result is received through the management server 200, the processor 130 may control the print engine 120 or the scanner 170 to perform the job requested by the user by means of the second application. For example, in a case in which a job requested by a user is a copy job, the processor 130 may control the scanner 170 to scan a manuscript, and when scan data is generated in the scanner 170, control the print engine 120 to print the generated scan data.

In a case in which a job requested by a user is sending a fax, the processor 130 may control the scanner 170 to scan a manuscript, generate scan data in the scanner 170, convert the generated scan data to fax data, and control the communication apparatus 140 to transmit the converted fax data to an address set by the user.

As described above, in the image forming system 1000 according to an example, a 3rd-party application may be installed and used and thus, a function of the image forming apparatus 100 may be readily expanded. In addition, authentication information used in an authentication process is retained until a payment step and thus, an unnecessary authentication process is no longer needed in the payment step. In addition, by means of a second application pre-installed in the image forming apparatus 100, a basic function control, calculation of a payment amount, data transfer between applications, etc. of the image forming apparatus 100 are supported and thus, a 3rd-party engineer can more readily develop a third-party application.

In FIG. 3, it is described that the elements such as a fingerprint scanner for using biometric information, a card reader (or a card terminal) for reading a card, etc. are separate apparatuses from the image forming apparatus 100. However, in an example, a fingerprint scanner, a card reader, etc. may be additional elements of the image forming apparatus 100 because they may be dependently connected to the image forming apparatus 100 and operated. In addition, the elements described above may be implemented in a form of being physically connected to the image forming apparatus 100.

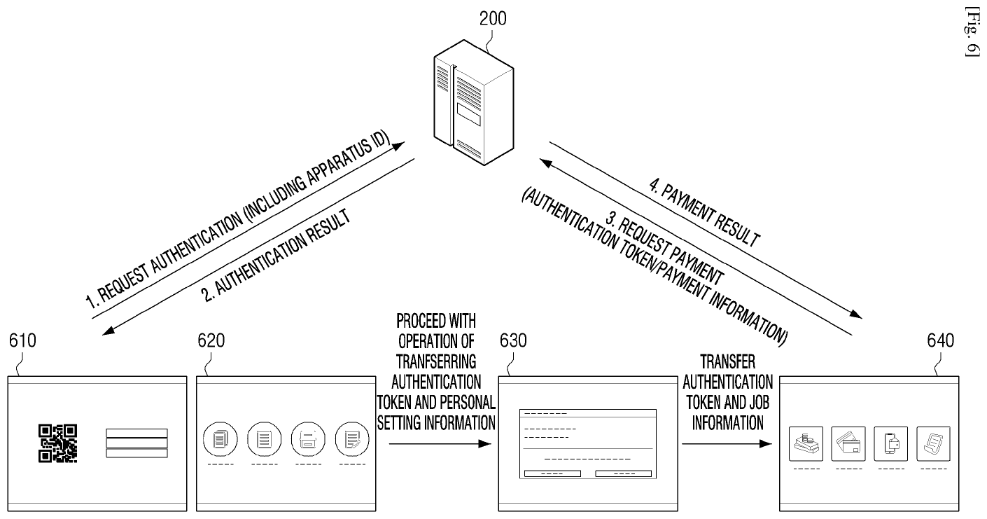

FIG. 4 is a diagram provided to explain an authentication and payment operation, according to a first example. In the first example, it will be assumed that the management server 200 provides an authentication token.

Referring to FIG. 4, the image forming apparatus 100 may display a user interface window 410 for receiving an input of user information by means of a first application, and receive input of user information via the displayed user interface window 410. The user information may include, for example, an ID/PW, QR code, pin code, etc.

When user information is received, the image forming apparatus 100 may transmit, to the management server 200, the received user information together with information capable of identifying the image forming apparatus 100 according to an operation of the first application, and receive the authentication result from the management server 200. The authentication result may include an authentication token, and the authentication token may include information relating to an expiry period.

When the authentication result is received, the image forming apparatus 100 may provide the authentication token to the second application according to an operation of the first application. Thereafter, the image forming apparatus 100 may display a user interface window 420 for selecting a function of the image forming apparatus 100 according to an operation of the second application, and receive an input of a function of the image forming apparatus 100, an option for the selected function, etc. through the displayed user interface window 420.

When a command to perform a job is received from a user, the image forming apparatus 100 may display a user interface window 430 confirming whether to perform a job according to an operation of the second application. When it is confirmed to perform the job through the displayed user interface window 430, the image forming apparatus 100 may transfer job information (e.g., a charged amount) and an authentication token to the third application.

The image forming apparatus 100 may transmit a request for payment including an authentication token and payment information to the management server 200 according to an operation of the third application, and receive a payment result from the management server 200.

When information indicating that a payment has been processed is received from the management server 200, the image forming apparatus 100 may perform a job requested by the user according an operation of the second application without displaying an additional UI.

FIG. 5 is a diagram provided to explain an authentication and payment operation, according to a second example. In the second example, it will be assumed that the management server 200 includes a plurality of servers.

Referring to FIG. 5, the image forming apparatus 100 may display a user interface window 510 for receiving an input of user information by means of a first application, and receive an input of user information via the displayed user interface window 510. The user information may include, for example, an ID, a password, etc.

When the user information is received, the image forming apparatus 100 may transmit the received user information to a first management server 200-1 (e.g., an authentication server) according to an operation of the first application, and receive the authentication result from the first management server 200-1. The authentication result may include, for example, authentication information and user setting information such as user information, price information, payment method information, and the like.

When the authentication result is received, the image forming apparatus 100 may provide the authentication result to the second application according to an operation of the first application. Thereafter, the image forming apparatus 100 may store the received authentication result in the memory 110 according to an operation of the second application. In addition, the image forming apparatus 100 may display a user interface window 520 for selecting a function and functional option of the image forming apparatus 100 according to an operation of the second application, and receive an input of a function of the image forming apparatus 100, an option for the selected function, etc. through the displayed user interface window 520.

When a command to perform a job is received from a user, the image forming apparatus 100 may calculate a charged amount according to an operation of the second application. The image forming apparatus 100 may calculate a charged amount according to price information included in the received personal setting information, and display a user interface window 530 which confirms whether to proceed with payment in a payment method preset by the user.

When a command to perform a job is received from the user, the image forming apparatus 100 may drive a third application corresponding to the payment method preset by the user, and provide an authentication token and job information to the driven third application.

In addition, the image forming apparatus 100 may display a user interface window 540 to proceed with payment according to an operation of the third application, and provide a second management server 200-2 (e.g., a payment server) with information required for payment and request payment.

When information indicating that payment has been processed is received from the second management server 200-2, the image forming apparatus 100 may provide the second application with the information according to an operation of the third application. In addition, the image forming apparatus 100 may perform a job requested by a user according to an operation of the second application.

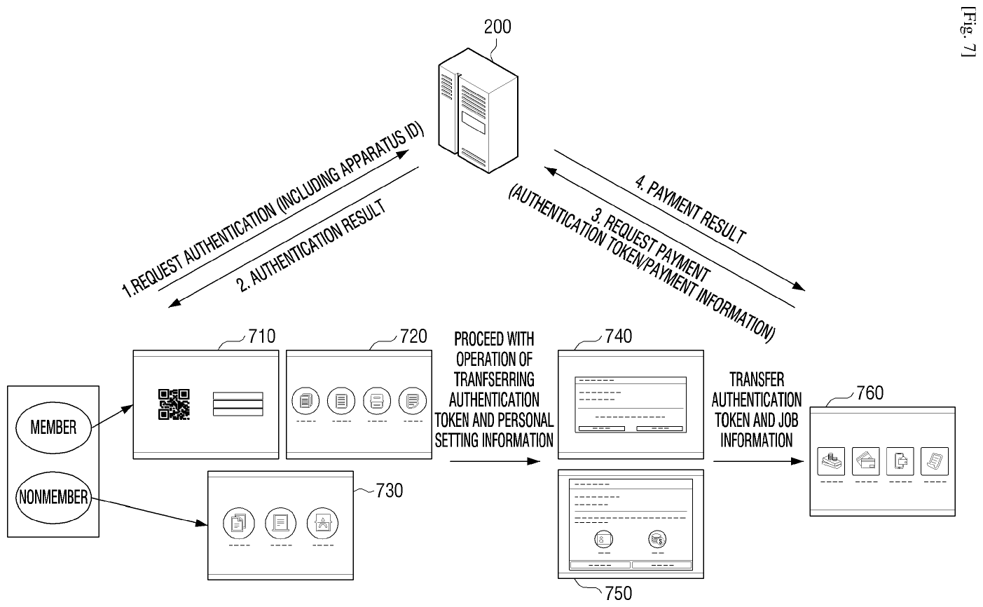

FIG. 6 is a diagram provided to explain an authentication and payment operation, according to a third example. In the third example, it is assumed that the third application supports a plurality of payment methods.

Referring to FIG. 6, the image forming apparatus 100 may receive an input of user information through a user interface window 610 for receiving an input of user information by means of a first application.

When the user information is received, the image forming apparatus 100 may transmit the received user information to a management server 200 according to an operation of the first application, and receive the authentication result from the management server 200. The authentication result may include not only authentication information, such as an authentication token, but also personal setting information.

When the authentication result is received, the image forming apparatus 100 may provide the authentication token and the personal setting information to the second application according to an operation of the first application. Thereafter, the image forming apparatus 100 may display a user interface window 620 corresponding to the personal setting information included in the authentication result according to an operation of the second application, and receive an input of a function of the image forming apparatus 100, an option for the selected function, etc. through the displayed user interface window 620.

When a command to perform a job is received from a user, the image forming apparatus 100 may calculate a charged amount according to price information included in the received personal setting information according to an operation of the second application, and display a user interface window 630 confirming whether to proceed with a job.

When it is confirmed to proceed with a job through the user interface window 630, the image forming apparatus 100 may transfer a charged amount and an authentication token to the third application.

In addition, the image forming apparatus 100 may display a user interface window 640 for a user to select any one of a plurality of payment methods according to an operation of the third application, and receive selection of a payment method via the displayed user interface window 640. Thereafter, the image forming apparatus 100 may transmit a request for payment to the management server 200 according to an operation of the third application, and receive the payment result from the management server 200.

When information indicating that a payment has been processed is received from the management server 200, the image forming apparatus 100 may perform a job requested by the user according an operation of the second application.

FIG. 7 is a diagram provided to explain an authentication and payment operation, according to a fourth example. In the fourth example, an environment is assumed in which both a registered user and an unregistered user are capable of using an image forming apparatus.

Referring to FIG. 7, the image forming apparatus 100 may select whether a current user is a registered user or an unregistered user. For this purpose, the image forming apparatus 100 may display a user interface window for selecting a type of user (e.g., member, nonmember, etc.) by using a second application.

If the current user is a registered user (e.g., member), the image forming apparatus 100 may display a user interface window 710 for receiving an input of user information by means of a first application, and receive input of user information via the displayed user interface window 710.

When the user information is received, the image forming apparatus 100 may transmit the received user information to a management server 200 according to an operation of the first application, and receive the authentication token and the personal setting information from the management server 200.

In addition, the image forming apparatus 100 may provide the authentication result to the second application according to an operation of the first application. The image forming apparatus 100 may display a user interface window 720 corresponding to the received personal setting information according to an operation of the second application, and receive an input of a function of the image forming apparatus 100, an option for the selected function, etc. through the displayed user interface window 720.

In contrast, if the user is an unregistered user (e.g., nonmember), the image forming apparatus 100 may display a user interface window 730 which is capable of performing only a limited function compared with a registered user according to an operation of the second application, and receive an input of a function and option of the image forming apparatus 100 via the displayed user interface window 730.

When a command to perform a job is received from a user, the image forming apparatus 100 may calculate a charged amount according to an operation of the second application. If the current user is a registered user, the image forming apparatus 100 may calculate a charged amount according to price information included in the received personal setting information, and display a user interface window 740 which confirms whether to proceed with payment in a payment method preset by the user.

If a command to perform a job is received from an unregistered user, the image forming apparatus 100 may display a user interface window 750 for selecting a payment method selectable by a user, and select any one payment method. When a payment method is selected, the image forming apparatus 100 may drive a third application corresponding to the payment method, display a user interface window 760 for payment according to the driven third application, and request payment by providing information required for payment to the management server 200.

When information indicating that a payment has been processed is received from the management server 200, the image forming apparatus 100 may perform a job requested by the user according to an operation of the second application.

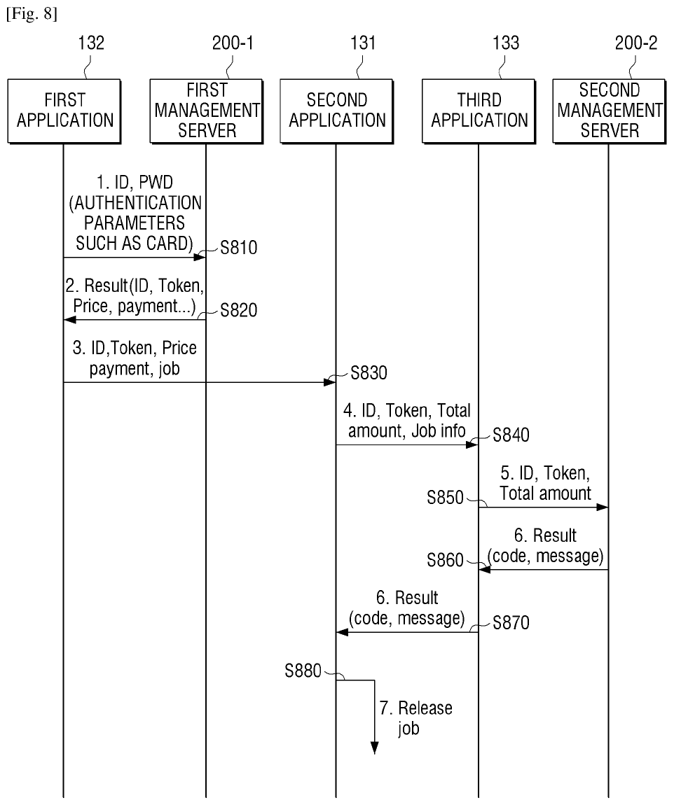

FIG. 8 is a sequence diagram provided to explain an operation in a plurality of applications and a plurality of servers, according to an example.

Referring to FIG. 8, a first application 132 may provide personal information received from a user to a first management server (e.g., an authentication server) 200-1, at operation S810.

The first management server 200-1 receiving personal information may identify whether the user is an authenticated user with reference to pre-stored user information, and provide the authentication result including authentication information corresponding to the identification result to the first application 132, at operation S820.

The first application 132 confirming that the user is an authenticated user may transfer the authentication result to a second application 131, at operation S830.

The second application 131 may receive a command to perform a job from the user, and transfer information including authentication information, a charged amount, etc., to a third application 133 for payment processing, at operation S840.

The third application 133 may transmit the received authentication information and the received charged amount to a second management server 200-2 at operation S850, and receive the payment result from the second management server 200-2 (i.e., a payment processing server or a payment server) at operation S860.

If the payment is processed successfully, the third application 133 may provide the second application 131 with information indicating that the payment has been successful, at operation S870. Thereafter, the second application 131 may perform a function requested by the user, at operation S880.

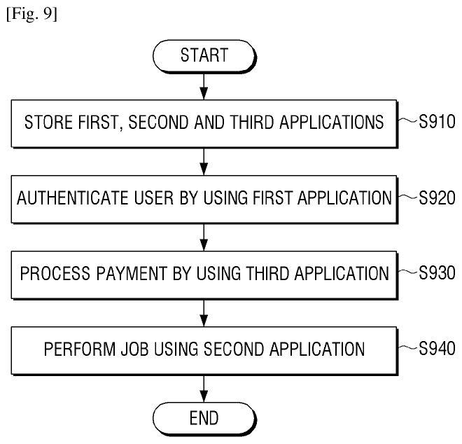

FIG. 9 is a diagram of a print controlling method, according to an example.

Referring to FIG. 9, a first application which is associated with user authentication, a second application which is associated with performing a function of an image forming apparatus, and a third application which is associated with payment processing may be stored at operation S910. The first application and the third application may be 3rd-party applications, and the second application may be an application provided by the manufacturer.

User authentication is performed using the first application, at operation S920. For example, when the first application performs user authentication using data stored in the management server 200, user information may be transmitted to the management server 200 and the authentication result may be received from the management server 200.

In addition, authentication information from among the authentication result provided by the first application may be provided to the third application, and payment is processed using the provided authentication information and the third application, at operation S930. For example, when the authentication result including authentication information is received via the first application, the second application may provide the authentication information to the third application when the payment is processed. The third application receiving the authentication information may perform a payment processing operation using the provided authentication information without receiving additional user information.

When the payment processing is completed, the user authentication is performed using the second application, at operation S940.

Accordingly, in the print controlling method according to an example, a 3rd-party application may be installed and used and thus, a function of the image forming apparatus 100 may be readily expanded. In addition, in the print controlling method, a basic function control, calculation of a payment amount, data transfer between applications, etc. of the image forming apparatus 100 are supported by means of a second application pre-installed in the image forming apparatus 100 and thus, a 3rd-party engineer can more readily develop a third-party application.

The print controlling method described above may be implemented as a program and provided to an image forming apparatus. In particular, the program including a print controlling method according to examples may be stored in a non-transitory computer readable medium and provided therein.

The non-transitory computer readable medium refers to a medium that stores data semi-permanently rather than storing data for a very short time, such as a register, a cache, a memory or etc., and is readable by an apparatus. In more detail, the above-described various applications or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

The foregoing examples and advantages are merely exemplary and are not to be construed as limiting the present disclosure. Furthermore, the foregoing examples and advantages can be readily applied to other types of apparatuses. Also, the description of the examples of the present disclosure is intended to be illustrative, and not to limit the scope of the claims, and many alternatives, modifications, and variations will be apparent to those skilled in the art.

1. An image forming apparatus, comprising:
a print engine to perform a print job;
a memory to store a first application associated with user authentication, a second application associated with performing a function of the image forming apparatus, and a third application associated with payment processing; and
a processor to:
perform a user authentication using the first application,
perform a payment processing by providing authentication information of the first application to the third application during a payment operation for an authenticated user, and
based on the payment processing being completed, control the print engine to perform an operation requested by a user by using the second operation.

2. The image forming apparatus as claimed in claim 1, wherein the first application and the third application are 3rd-party applications which are provided from an external apparatus and installed in the image forming apparatus.

3. The image forming apparatus as claimed in claim 1, further comprising:
a display,
wherein the processor:
controls the display to display a user interface (UI) screen for receiving an input of authentication information provided by the first application, and
based on authentication information being received from a user,
performs an authentication processing using the first application.

4. The image forming apparatus as claimed in claim 3, further comprising:
a communication apparatus to communicate with an external server,
wherein the processor:
controls the communication apparatus to provide the received authentication information to the external server using the first application, and
receives an authentication token for an authenticated user from the external server.

5. The image forming apparatus as claimed in claim 4, wherein the processor provides the received authentication token to the third application during a payment processing for a user inputting authentication information.

6. The image forming apparatus as claimed in claim 4,
wherein the communication apparatus receives user setting data for an authenticated user, and
wherein the processor controls the display to display a user interface window for controlling a function of the image forming apparatus by using the received user setting data and the second application.

7. The image forming apparatus as claimed in claim 1, wherein the processor:
calculates a payment amount corresponding to an operation requested by a user by using the second application, and
provides the authentication information to the third application.

8. The image forming apparatus as claimed in claim 7, further comprising:
a communication apparatus to communicate with a payment server,
wherein the processor performs a payment processing by providing the calculated payment amount and the authentication information to the payment server by using the third application.

9. The image forming apparatus as claimed in claim 1, wherein the processor, based on a plurality of third applications associated with payment processing being installed, performs a payment processing by driving a third application corresponding to a payment processing method selected by a user and providing the authenticated user to the driven third application.

10. The image forming apparatus as claimed in claim 1, further comprising:
a communication apparatus to receive, from an external apparatus, an installation file corresponding to a new application,
wherein the processor:
installs the received installation file in the image forming apparatus, and
registers the new application as the first application or the third application according to a type of the new application.

11. A print controlling method of an image forming apparatus, the method comprising:
storing a first application associated with user authentication, a second application associated with performing a function of the image forming apparatus, and a third application associated with payment processing;
performing a user authentication using the first application;
performing a payment processing by providing authentication information of the first application to the third application; and
based on a payment processing being completed, performing an operation requested by a user by using the second application.

12. The print controlling method as claimed in claim 11, wherein the first application and the third application are 3rd-party applications which are provided from an external apparatus and installed in the image forming apparatus.

13. The print controlling method as claimed in claim 11, wherein the performing of the user authentication comprises:
providing the received authentication information to an external server by using the first application; and
receiving an authentication token for an authenticated user from the external server.

14. The print controlling method as claimed in claim 13, wherein the performing of the payment processing comprises:
providing the received authenticated token to the third application by using the second application; and
performing a payment processing using the third application and the provided authentication token.

15. The print controlling method as claimed in claim 13,
wherein the performing of the user authentication comprises receiving, from the external server, user setting data for an authenticated user, and
wherein the print controlling method further comprises displaying a user interface window for controlling a function of the image forming apparatus by using the received user setting data and the second application.
